(19) United States
(12) Patent Application Publication
(10) Pub. No.: US 2022/0311777 A1
(43) Pub. Date: Sep. 29, 2022

(54) HARDENING REMOTE ADMINISTRATOR ACCESS

(71) Applicant: Saudi Arabian Oil Company, Dhahran (SA)

(72) Inventors: Abdulaziz Al Makenzi, Dammam (SA); Abdulaziz Abdulrahman Alrushaid, Al Khobar (SA); Mohamed Yessouf Danialou, Dhahran (SA); Idiris Mohamed, Dhahran (SA); Ibrahim A. Tohary, Dammam (SA)

(73) Assignee: Saudi Arabian Oil Company, Dhahran (SA)

(21) Appl. No.: 17/213,784

(22) Filed: Mar. 26, 2021

(51) Int. Cl. H04L 29/06

(52) U.S. Cl. CPC H04L 63/105; H04L 63/0263

(57) ABSTRACT

A method of securing remote privileged access to computing resources comprises authenticating an admin user at a user access authorization layer, receiving a request to enable remote privileged access, verifying the request originated from an administrator computing device, receiving confirmation of a valid trouble ticket or change request relevant to the admin user's account, and, in response, enabling remote privileged access for the admin user. Enabling remote privileged access includes enabling the admin user's account and adding the admin user to a remote admin security group in a network directory service, and updating a whitelist and firewall to allow execution and network traffic of a client application for the admin user. The remote privileged access is automatically disabled after a set time duration.

### TECHNICAL FIELD

The present specification generally relates to computer security and, more specifically, to systems and methods for providing hardened remote administrator access to computer systems through a network.

### BACKGROUND

Remote administration of computing resources provides additional flexibility and can help to improve the operations and availability of computing resources. However, the ability to provide privileged access to computing resources remotely also opens new opportunities for security risks. Once privileged admin accounts are provided remote administrative access, that access may be exploited by bad actors to gain unauthorized access to data or computing resources. As remote administrative access becomes a necessary component of enterprise computing resource management, additional security measures must be taken in order to maintain acceptable levels of security and service.

Accordingly, a need exists for systems and methods for hardening security for remote access of privileged administrator accounts.

### SUMMARY

In a first aspect of the disclosed embodiments, a method of securing remote privileged access to computing resources includes receiving, from an admin user, a request to enable remote privileged access, receiving confirmation of a valid trouble ticket or change request relevant to the admin user's account, and enabling remote privileged access for the admin user. Enabling remote privileged access may include enabling the admin user's account in a network directory service, adding the admin user to a remote administrator security group in the network directory service, updating a network endpoint security tool whitelist to allow execution of remote desktop protocol (RDP) or secure shell (SSH) for the admin user, and updating a firewall to allow network traffic for RDP or SSH for the admin user.

In a second aspect of the disclosed embodiments, the method of the first aspect further includes enabling remote privileged access for a set time duration, and disabling remote privileged access for the admin user in response to expiration of the time duration.

In yet another embodiment based on any of the first or second aspects, the method may include verifying the request originated from an administrator computing device.

In other embodiments, a processor and memory are configured to perform any of the disclosed methods, or a non-volatile computer readable medium storing instruction that, when executed by a processor, cause the processor to perform steps of any of the described embodiments.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 illustrates a block diagram of a computing network for hardening remote administrator access, according to one or more embodiments shown and described herein;

FIG. 2 illustrates a flowchart of a method for managing remote administrator access, according to one or more embodiments shown and described herein;

FIG. 3 illustrates a swimlane diagram of a system and method for hardening remote administrator access, according to one or more embodiments shown and described herein; and

FIG. 4 illustrates a block diagram of a computing device, according to one or more embodiments shown and described herein.

### DETAILED DESCRIPTION

The disclosed embodiments relate to systems and methods for hardening security for remote access of privileged administrator accounts. Information technology (IT) infrastructure comprises multiple technologies that are configured to provide technology services to an organization's users. These technology services and systems may be configured and managed through system administrators who have privileged access to IT resources. IT resources may include any hardware, software or combination thereof that provides, storage, computing, or communication functions or services in an IT infrastructure. Access to privileged admin accounts is typically restricted to avoid misuse that may result in security risks, loss of data, and interruption of IT services. As more organizations allow users, including system admins, to access IT resources remotely, maintaining security of the remote connections becomes a growing concern. The disclosed embodiments provide system administrators remote access by automating access through Remote Desktop Protocol (RDP) on the secure sockets layer (SSL) virtual private network (VPN), allowing system administrators to operate securely from a remote location.

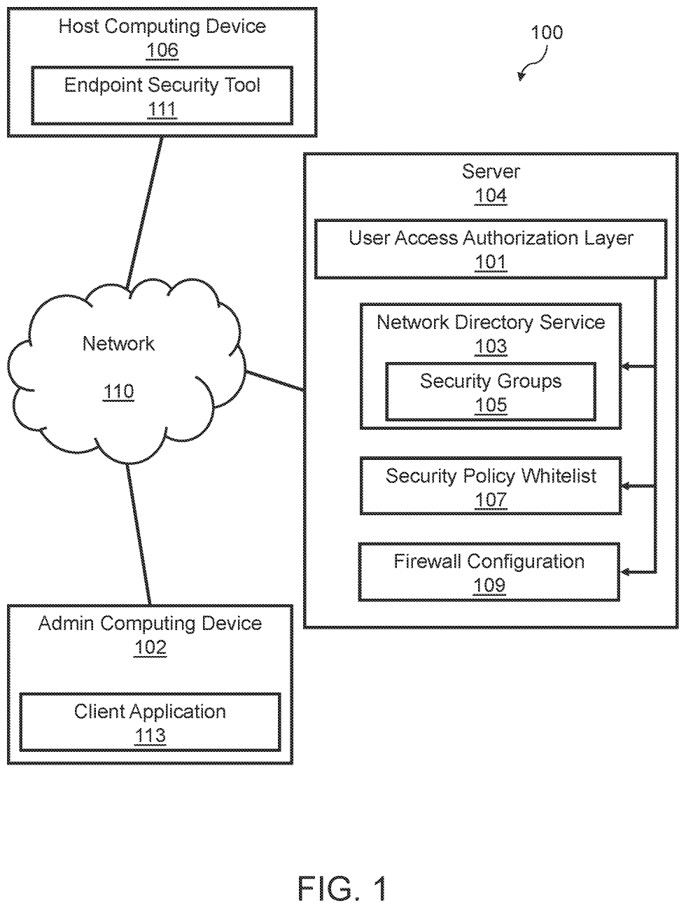

FIG. 1 illustrates a block diagram of a computing network for hardening remote administrator access, according to one or more embodiments shown and described herein. According to some embodiments, the system 100 may include a server 104, an admin computing device 102, and a host computing device 106 connected to each other through a network 110. The server 104 may include a user access authorization layer 101, a network directory service 103 that includes security groups 105, a security policy whitelist 107, and a firewall configuration 109. The user access authorization layer 101, network directory service 103, security groups 105, security policy whitelist 107, and firewall configuration 109 may be implemented and/or stored using other computing devices, including but not limited to remote, distributed, virtual, or cloud based computing devices.

The network directory service 103 may include any tool that enables creation and management of domains, users, and objects within a network. A network directory service may include one or more user security groups 105 which identify specific access privileges granted to users in a group for certain directories, services and resources on the network. Network directory services, such as, but not limited to, Microsoft® Active Directory®, are known, and any network directory service may be used to implement the disclosed embodiments.

The security policy whitelist 107 defines a set of applications or services that are authorized to run on one or more host computing devices 106 of an organization's network. The security policy whitelist 107 may be referenced by an endpoint security tool 111 running on one or more host computing devices 106 of the organization's network. The endpoint security tool 111 may be an application or service that manages applications running on the host computing device 106, and prevents execution of unauthorized applications and services. Endpoint security tools 111 are known and one non-limiting example of an endpoint security tool 111 suitable for implementing the disclosed embodiments is Bit9® provided by VMWare® Carbon Black™. A person of ordinary skill in the art will understand that any endpoint security tool capable of whitelisting applications or services will be suitable for implementing the disclosed embodiments.

A firewall is a network security device that monitors incoming and outgoing network traffic and permits or blocks network traffic based on security rules. A firewall may be implemented using hardware, software, or a combination thereof. The firewall configuration 109 may define the security rules used by the firewall to permit or deny traffic on the network. A person of ordinary skill in the art will understand that any network security tool that can be configured to selectively permit or block network traffic based on the origin, destination, IP address, port, or application may be used as a firewall in implementing the disclosed embodiments.

The admin computing device 102 may connect remotely to the host computing device 106 using a client application 113 and perform administrative tasks on the host computing device 106. The client application 113 may include, but is not limited to remote desktop protocol (RDP) or a secure shell (SSH) client. A person of skill in the art will understand that any client application that enables connection to a host computing device 106 and performance of tasks such as changing configuration, reading or writing data, or power cycling a device may be used to implement the disclosed embodiments. Throughout this application, although RDP and SSH are used as non-limiting examples, it is to be understood that other client applications 113 may also be used.

The user access authorization layer 101 automatically manages security access controls for an admin user that uses the admin computing device 102 to connect to the host computing device 106. The user access authorization layer 101 may be configured to manage configuration of the security policy whitelist 107, the firewall configuration 109, and the network directory service 103, including the security groups 105 of the network directory service 103.

One or more of the server 104, the admin computing device 102 or the host computing device 106 may comprise any computing device as described in the disclosed embodiments. One or both of the host computing device 106 and the network 110 may comprise a firewall that manages incoming and outgoing traffic of a local area network or to and from the host computing device 106.

In the disclosed embodiments, the network 110 may include one or more computer networks (e.g., a personal area network, a local area network, grid computing network, wide area network, etc.), cellular networks, satellite networks, the internet, a virtual network in a cloud computing environment, and/or any combinations thereof. Accordingly, the components of the system 100 may be communicatively coupled to the network 110 via a wide area network, via a local area network, via a personal area network, via a cellular network, via a satellite network, via a cloud network, or the like. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB, Serial ATA, eSATA, and FireWire. Suitable cellular networks include, but are not limited to, technologies such as LTE, WiMAX, UMTS, CDMA, and GSM. The network 110 may include one or more wireless access points to be used by the system 100 to access one or more servers 104 or the host computing device 106.

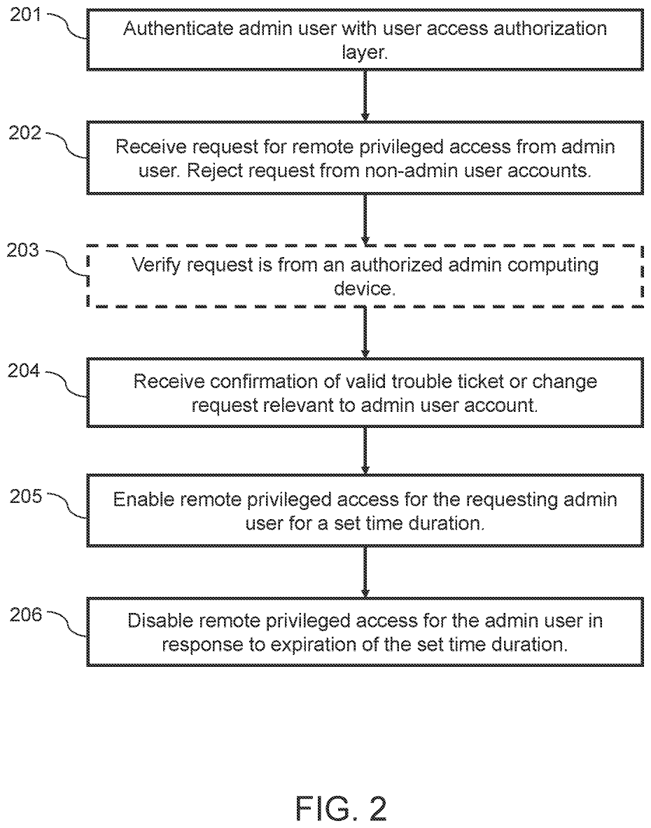

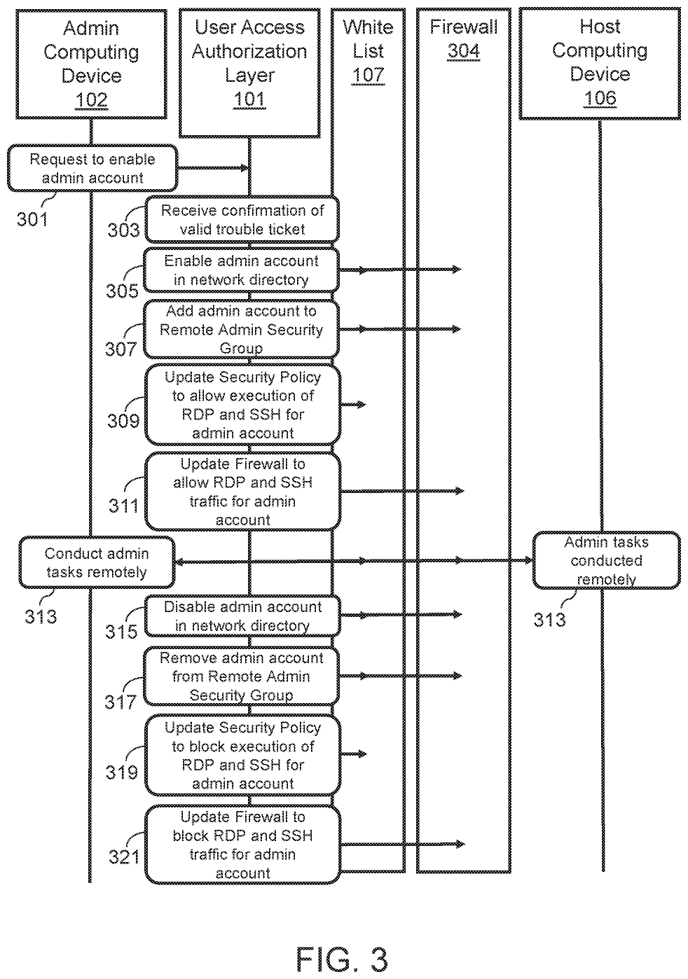

According to some embodiments, an admin user may use the admin computing device 102 to connect to the user access authorization layer 101. The admin user's account may be disabled by default, preventing privileged access to the host computing device 106, while allowing the admin user to connect to the user access authorization layer 101 for the purpose of enabling remote privileged access for the admin user. The user access authorization layer 101 may provide services allowing the admin user to connect to the user access authorization layer 101 and request enablement of the admin user's account for remote privileged access to the host computing device 106. The user access authorization layer 101 may automatically verify that the admin user is authorized to enable remote privileged access, add the admin user to the security policy whitelist 107, and enable the client application 113 traffic for the admin user through the firewall. The process of enabling remote privileged access for the admin user is described in greater detail with reference to FIG. 2 and FIG. 3.

FIG. 2 illustrates a flowchart of a method for managing remote administrator access, according to one or more embodiments shown and described herein. At step 201, an admin user may use the admin computing device 102 to connect to the user access authorization layer 101 and authenticate as a valid admin user. The authentication process for the admin user connecting to the user access authorization layer 101 may be performed using any known user authentication process.

At step 202, the user access authorization layer 101 may receive a request for remote privileged access from the admin user. According to some embodiments, requests for remote privileged access received from non-admin users are rejected, and/or non-admin users are denied authentication or otherwise not allowed to connect to the user access authorization layer 101.

At step 203, according to some embodiments, the user access authorization layer 101 may verify the request came from an authorized admin computing device 102. According to some embodiments, each authorized admin computing device may be assigned a unique secret identifier. The admin computing device 102 may send the unique secret identifier to the user access authorization layer 101 in association with the request for remote privileged access. One or both of the request and the unique secret identifier may be sent using encrypted communications. The user access authorization layer 101 may verify that the admin computing device 102 is authorized by checking a device whitelist to find the unique secret identifier. According to some embodiments, the device whitelist may be encrypted. In response to finding that the unique secret identifier exists in the device whitelist, the user access authorization layer 101 may proceed with enabling remote privileged access for the admin user. In response to finding that the unique secret identifier is not in the device whitelist, the user access authorization layer 101 may reject the request for remote privileged access.

Limiting connections to authorized admin computing devices 102 may help to ensure that only an admin user with physical access to an admin computing device 102 may gain remote privileged access through the user access authorization layer 101. Thus, even if a bad actor manages to obtain an admin user's login credentials, these credentials cannot be used to gain remote privileged access from another computing device. If stolen admin user credentials are submitted to the user access authorization layer 101, a security alert may be generated, notifying network supervisors or administrators to take appropriate remedial action.

In response to the request to enable remote privileged access for the admin user's account, the user access authorization layer 101 may verify that a valid trouble ticket or change request exists that is relevant to the admin user account. According to some embodiments, the admin user is granted remote privileged access only if a valid trouble ticket or change request exists. This prevents admin user privileges from being used to make changes or gain privileged access without specific reason and authorization to do so. Thus, even if admin credentials are stolen, they may not be used to gain remote privileged access to computing resources unless a valid trouble ticket or change request exists. A bad actor would need to somehow generate a valid trouble ticket in addition to stealing admin credentials and additionally, in some embodiments, obtaining or simulating physical access to an authorized admin computing device 102.

According to some embodiments, the user access authorization layer 101 may send a verification request to an admin supervisor. The admin supervisor may confirm the existence of a valid trouble ticket or change request relevant to the admin user. A valid trouble ticket or change request may be an open or pending trouble ticket or change request that is not fixed, resolved, or closed (unresolved), not already assigned to another admin user (unassigned), and not expired due to excessive age (unexpired).

According to some embodiments, trouble tickets or change requests may be generated when a user of the system reports a problem, such as, but not limited to, inability to sign in, failure to execute an application, issues sending or receiving email, hardware or software issues, or software installation requests. A trouble ticket may identify a specific task to be performed and a category for the task, or a specific category of the problem to be solved. Each admin user may also be associated with one or more task or task categories. In order to be granted privileged access, one or more categories associated with the requesting admin user must match the category of the trouble ticket or change request. A trouble ticket or change request may be determined to be valid when the IT resource for which privileged access is being requested is associated with the trouble ticket or change request. As a non-limiting example, if a system user reported a problem that requires privileged access to the system user's machine or the system user's account, verifying that a valid trouble ticket or change request exists may include confirming a machine of the system user, confirming an account of the system user, or confirming that the trouble ticket or change request is associated with the account of the system user. According to some embodiments, the admin supervisor may determine whether any open trouble tickets or change requests are relevant to the admin user. At step 204, the user access authorization layer 101 receives confirmation that a valid trouble ticket or change request exists that is relevant to the admin user account.

At step 205, the user access authorization layer 101 enables remote privileged access for the requesting admin user. According to some embodiments, the user access authorization layer 101 may be configured to prevent enabling remote privileged access for an admin user other than the requesting admin user. This prevents using one admin account to gain remote privileged access for another admin account. This also prevents gaining privileged access outside the scope of privilege granted to an admin user for whom a relevant trouble ticket or change request exists. The process of enabling remote privileged access for the admin user is described in greater detail with reference to FIG. 3.

According to some embodiments, remote privileged access is enabled for the admin user for a set time duration. At step 206, the user access authorization layer 101 disables remote privileged access for the admin account. Remote privileged access may be disabled in response to expiration of the set time duration. The time duration improves security by eliminating the need for an admin user to take any action to disable remote privileged access after performing necessary administrative tasks. This prevents remote privileged access from remaining enabled for an extended duration, and minimizes the window of opportunity for a security attack.

FIG. 3 illustrates a swimlane diagram of a system and method for hardening remote administrator access, according to one or more embodiments shown and described herein. In the swimlane diagram of FIG. 3, the admin computing device 102, user access authorization layer 101, and host computing device 106 are shown at the top of the diagram. Below each component are actions that are performed by the respective component. A security policy whitelist 107 and a firewall 304 are also shown intervening between the admin computing device 102 and the host computing device 106. Traffic between the admin computing device 102 and the host computing device 106 must pass through the firewall 304, and the endpoint security tool 111 prevents execution of applications and services that are not included in the security policy whitelist 107. Arrows in FIG. 3 indicate communication between components, which may include modification of settings or configuration of the components.

At step 301, the admin user may request to enable remote privileged access for the admin user's account. According to some embodiments, this request may be sent after the admin user has successfully authenticated with the user access authorization layer 101.

At step 303, the user access authorization layer 101 may receive confirmation of a valid trouble ticket or change request relevant to the admin user. In response to validating an existing valid trouble ticket or change request, the user access authorization layer 101 may enable remote privileged access for the admin user.

Enabling remote privileged access may comprise enabling the admin user's account in the network directory service at step 305, and adding the admin user's account to a remote admin security group in the network directory at step 307. The remote admin security group may comprise a security group specifically created for admin users that are granted remote privileged access. The remote admin security group may be distinct from an admin security group that identifies users who are granted non-remote privileged access. The admin security group may be used for authenticating the admin user that requests the user access authorization layer 101 to enable the admin account for remote privileged access. Therefore, according to some embodiments, an admin user account may be enabled in the admin security group and disabled in the remote admin security group.

The user access authorization layer 101, in response to authenticating the admin user and verifying the existence of a valid trouble ticket relevant to the admin user, may further update the security policy whitelist at step 309 to allow execution of one or more client applications 113 for the admin account. The one or more client applications 113 may include but are not limited to remote desktop protocol (RDP) and secure shell (SSH). Other applications may also be whitelisted, and a person of skill in the art will understand that any application for which remote privileged access is to be granted may be added to the whitelist for the admin user in order to allow remote privileged access and execution by the admin user.

In response to authenticating the admin user and verifying the existence of a valid trouble ticket relevant to the admin user, at step 311, the user access authorization layer 101 may further update the firewall configuration 109 to allow network traffic of the one or more client applications 113, including but not limited to RDP and SSH. When the requesting admin user's account is enabled and added to the remote admin security group, and the security policy whitelist and firewall configuration are updated to allow execution and network traffic of the client applications 113 required by the admin user to perform administrator tasks, the admin user may then connect to the host computing device 106 and remotely conduct administrative tasks at step 313.

After administrative tasks are completed, the user access authorization layer 101 may disable remote privileged access for the admin user. Disabling remote privileged access may include disabling the admin user's account in the network directory at step 315, removing the admin user's account from the remote admin security group at step 317, updating the security policy whitelist at step 319 to remove client applications 113 that were added in the enablement step, and updating the firewall at step 321 to block traffic of the client applications 113 for the admin user's account.

According to some embodiments, the admin user's account is enabled for a set time duration, and the admin account is automatically disabled in response to expiration of the set time duration.

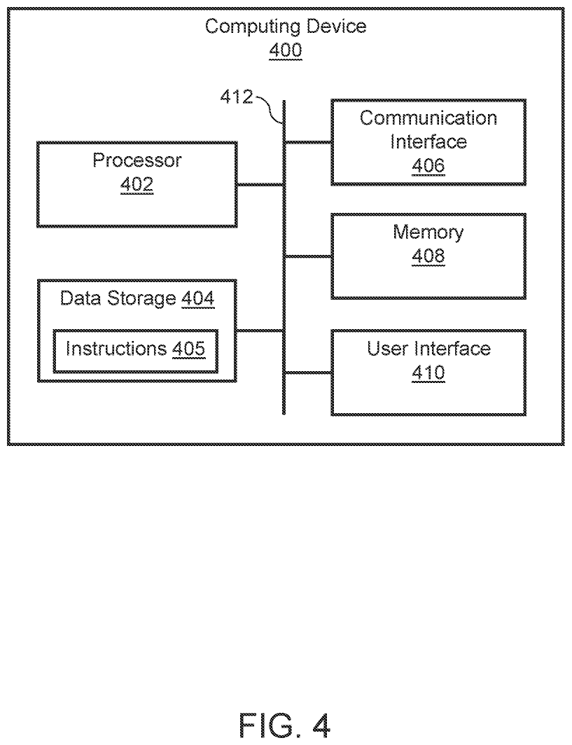

FIG. 4 illustrates a block diagram of a computing device 400, according to one or more embodiments shown and described herein. As shown, computing device 400 may include a processor 402, and data storage 404 including instructions 405. The computing device 400 may further include a communication interface 406, a memory 408, and a user interface 410, each of which are communicatively connected via a system bus 412. Any component or combination of components of the disclosed embodiments may take the form of or include a computing device 400. It should be understood that computing device 400 may include different and/or additional components, and some or all of the functions of a given component could instead be carried out by one or more different components. Computing device 400 may take the form of (or include) a virtual computing device or one or more computing resources in a cloud computing environment. Additionally, computing device 400 could take the form of (or include) a plurality of computing devices of any form, and some or all of the functions of a given component could be carried out by any combination of one or more of the computing devices in the plurality.

Processor 402 may take the form of one or more general-purpose processors and/or one or more special-purpose processors, and may be integrated in whole or in part with data storage 404, communication interface 406, memory 408, user interface 410, and/or any other component of computing device 400, as examples. Accordingly, processor 402 may take the form of or include a controller, an integrated circuit, a microchip, a central processing unit (CPU), a microprocessor, a system on a chip (SoC), a field-programmable gate array (FPGA), and/or an application-specific integrated circuit (ASIC), among other possibilities.

Data storage 404 may take the form of a non-transitory computer-readable storage medium such as a hard drive, a solid-state drive, an erasable programmable read-only memory (EPROM), a universal serial bus (USB) storage device, a compact disc read-only memory (CD-ROM) disk, a digital versatile disc (DVD), cloud-based storage, any other non-volatile storage, or any combination of these, to name just a few examples.

Instructions 405 may be stored in data storage 404, and may include machine-language instructions executable by processor 402 to cause computing device 400 to perform the computing-device functions described herein. Additionally or alternatively, instructions 405 may include script instructions executable by a script interpreter configured to cause processor 402 and computing device 400 to execute the instructions specified in the script instructions. According to some embodiments, the instructions include instructions executable by the processor 402 to cause the computing device 400 to execute an artificial neural network. It should be understood that instructions 405 may take other forms as well.

Additional data may be stored in data storage 404, such as databases, data structures, data lakes, and/or network parameters of a neural network. The additional data could be stored such as a table, a flat file, data in a filesystem of the data storage, a heap file, a B+ tree, a hash table, a hash bucket, or any combination of these, as examples.

Communication interface 406 may be any component capable of performing the communication-interface functions described herein, including facilitating wired and/or wireless communication between computing device 400 and another entity. As such, communication interface 406 could take the form of an Ethernet, Wi-Fi, Bluetooth, and/or USB interface, among many other examples. Communication interface 406 may receive data over a network 110 via communication links, for instance.

Memory 408 could take the form of any type of main computer memory, including but not limited to random access memory (RAM), cache memory, register memory, or any other memory used to store instructions or data for rapid access by the processor 402, including storage of instructions during execution.

User interface 410 may be any component capable of carrying out the user input and output functions. For example, the user interface may be configured to receive input from a user and/or output information to the user. Output may be provided via a computer monitor, a loudspeaker (such as a computer speaker), or another component of (or communicatively linked to) computing device 400. User input might be achieved via a keyboard, a mouse, or other component communicatively linked to the computing device. As another possibility, input may be realized via a touchscreen display of the computing device in the form of a smartphone or tablet device. Some components may provide for both input and output, such as the aforementioned touchscreen display. It should be understood that user interface 410 may take numerous other forms as well.

System bus 412 may be any component capable of performing the system-bus functions described herein. In an embodiment, system bus 412 is any component configured to transfer data between processor 402, data storage 404, communication interface 406, memory 408, user interface 410, and/or any other component of computing device 400. In an embodiment, system bus 412 includes a traditional bus as is known in the art. In other embodiments, system bus 412 includes a serial RS-232 communication link, a USB communication link, and/or an Ethernet communication link, alone or in combination with a traditional computer bus, among numerous other possibilities. In some examples, system bus 412 may be formed from any medium that is capable of transmitting a signal, such as conductive wires, conductive traces, or optical waveguides, among other possibilities. Moreover, system bus 412 may be formed from a combination of mediums capable of transmitting signals. The system bus could take the form of (or include) an internal data bus of the computing device, a local area network (LAN), communication connections between components of the disclosed embodiments, or any combination of these mediums. It should be understood that system bus 412 may take various other forms as well.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method of securing remote privileged access to computing resources, the method comprising:
receiving, by a computing device, a request to enable remote privileged access to an information technology (IT) resource, wherein the request is initiated from an admin user, wherein the request is received in response to a trouble ticket or change request being generated for an issue related to the IT resource,
wherein the trouble ticket identifies a task category or task to be performed which requires privileged access to the IT resource;
determining, by the computing device, whether the trouble ticket or change request is valid, wherein determining whether the trouble ticket or change request is valid includes: determining that the trouble ticket or change request is open and remains unassigned, unresolved, and unexpired; and
in response to a determination that the trouble ticket or change request is valid, enabling, by the computing device, remote privileged access to the IT resource for the admin user.

2. The method of claim 1, wherein enabling remote privileged access comprises:
enabling the admin user's account in a network directory service.

3. The method of claim 2, wherein enabling remote privileged access further comprises:
adding the admin user to a remote administrator security group in the network directory service.

4. The method of claim 3, wherein enabling remote privileged access further comprises:
updating a network endpoint security tool whitelist to allow execution of a client application for the admin user.

5. The method of claim 4, wherein enabling remote privileged access further comprises:
updating a firewall to allow network traffic of the client application for the admin user.

6. The method of claim 5, wherein remote privileged access is enabled for a set time duration.

7. The method of claim 6, further comprising:
disabling remote privileged access for the admin user in response to expiration of the time duration.

8. A non-volatile computer readable medium storing instruction that, when executed by a processor, cause the processor to perform steps of:
receiving a request to enable remote privileged access to an information technology (IT) resource, wherein the request is initiated from an admin user, wherein the request is received in response to a trouble ticket or change request being generated for an issue related to the IT resource,
wherein the trouble ticket identifies a task category or task to be performed which requires privileged access to the IT resource;
determining, by the computing device, whether the trouble ticket or change request is valid, wherein determining whether the trouble ticket or change request is valid includes: determining that the trouble ticket or change request is open and remains unassigned, unresolved, and unexpired; and
in response to a determination that the trouble ticket or change request is valid, enabling, by the computing device, remote privileged access to the IT resource for the admin user.

9. The non-volatile computer readable medium of claim 8, wherein enabling remote privileged access comprises:
enabling the admin user's account in a network directory service.

10. The non-volatile computer readable medium of claim 9, wherein enabling remote privileged access further comprises:
adding the admin user to a remote administrator security group in the network directory service.

11. The non-volatile computer readable medium of claim 10, wherein enabling remote privileged access further comprises:
updating a network endpoint security tool whitelist to allow execution of a client application for the admin user.

12. The non-volatile computer readable medium of claim 11, wherein enabling remote privileged access further comprises:
updating a firewall to allow network traffic of the client application for the admin user.

13. The non-volatile computer readable medium of claim 12, wherein remote privileged access is enabled for a set time duration.

14. The non-volatile computer readable medium of claim 13, wherein the processor further performs a step of:
disabling remote privileged access for the admin user in response to expiration of the time duration.

15. A system for securing remote privileged access to computing resources, the system comprising:
one or more processors;
a memory;
wherein the one or more processors and memory are configured to execute instructions that cause the processor to perform the steps of:
receiving a request to enable remote privileged access to an information technology (IT) resource, wherein the request is initiated from an admin user, wherein the request is received in response to a trouble ticket or change request being generated for an issue related to the IT resource,
wherein the trouble ticket identifies a task category or task to be performed which requires privileged access to the IT resource;
determining, by the computing device, whether the trouble ticket or change request is valid, wherein determining whether the trouble ticket or change request is valid includes: determining that the trouble ticket or change request is open and remains unassigned, unresolved, and unexpired; and
in response to a determination that the trouble ticket or change request is valid, enabling, by the computing device, remote privileged access to the IT resource for the admin user.

16. The system of claim 15, wherein enabling remote privileged access comprises:
enabling the admin user's account in a network directory service.

17. The system of claim 16, wherein enabling remote privileged access further comprises:
adding the admin user to a remote administrator security group in the network directory service.

18. The system of claim 17, wherein enabling remote privileged access further comprises:
updating a network endpoint security tool whitelist to allow execution of a client application for the admin user.

19. The system of claim 18, wherein enabling remote privileged access further comprises:
updating a firewall to allow network traffic of the client application for the admin user.

20. The system of claim 19, wherein enabling remote privileged access further comprises disabling remote privileged access for the admin user in response to expiration of the time duration.
